(19) United States
(12) Patent Application Publication
(10) Pub. No.: US 2016/0162813 A1
(43) Pub. Date: Jun. 9, 2016

(54) INTEGRATION OF BIG-DATA ANALYSIS INTO AUDIT ENGAGEMENT SOFTWARE

(71) Applicants: Martin Hoffmann, Heidelberg (DE); Eric Berettoni, Wiesloch (DE); Martin Erdelmeier, Schifferstadt (DE); Vibeke Egetoft, Walldorf (DE)

(72) Inventors: Martin Hoffmann, Heidelberg (DE); Eric Berettoni, Wiesloch (DE); Martin Erdelmeier, Schifferstadt (DE); Vibeke Egetoft, Walldorf (DE)

(21) Appl. No.: 14/559,544

(22) Filed: Dec. 3, 2014

(51) Int. Cl. G06Q 10/06

(52) U.S. Cl. CPC G06Q 10/063

(57) ABSTRACT

According to an embodiment of the present disclosures, systems, methods, and non-transitory computer-readable mediums having program instructions thereon, provide for an audit management graphical user interface application incorporating big-data analysis of business data. In an embodiment, the audit management graphical user interface application analyzes the business data within discrete detection tasks. In an embodiment, the discrete detection tasks include detection strategies which act on the business data. In an embodiment, the business rules of a detection strategy pertain to certain business protocols and procedures. Accordingly, the audit management application provides the business or auditor a means of verifying that the controls (e.g., the business rules) established by the business to curb fraud are actually adhered to in the course of normal business activity.

### FIELD

The present disclosure relates generally to an audit management graphical user interface application incorporating big-data analysis in order to audit business data.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates an embodiment of a system utilizing the audit management application.

FIG. 2 illustrates an embodiment of a method of utilizing the audit management application.

FIG. 3 illustrates an embodiment of the interaction between the elements of the system.

FIG. 4A illustrates an embodiment of a page utilized to add a detection task.

FIG. 4B illustrates an embodiment of a page utilized to select a detection strategy for a detection task.

FIG. 4C illustrates an embodiment of a page utilized to create a detection strategy for a detection task.

FIG. 4D illustrates an embodiment of a page utilized to select the time frame for a control test of a detection task.

FIG. 4E illustrates an embodiment of a page depicting the details of the detection task.

FIG. 4F illustrates an embodiment of a page representing the contents of a working paper.

FIG. 4G illustrates an embodiment of a page utilized to classify irregularities in the working paper.

FIG. 4H illustrates another embodiment of the page representing the contents of a working paper.

### DETAILED DESCRIPTION

According to an embodiment of the present disclosures, systems, methods, and non-transitory computer-readable mediums having program instructions thereon, provide for an audit management graphical user interface application incorporating big-data analysis in order to audit business data. In an embodiment, the audit management graphical user interface application analyzes the business data within discrete detection tasks. In an embodiment, the discrete detection tasks include detection strategies which act on the business data. In an embodiment, the detection strategies are comprised of business rules. In an embodiment, the business rules of a detection strategy pertain to certain business protocols and procedures. For example, the business rules could correspond to an accounting policy manual (i.e., the internal rules) of a certain company. In an embodiment, the detection strategies are applied to the business data to determine if there are any irregularities with regard to the adherence to the business rules. In other words, the detection strategies are applied to determine if there is a violation or circumvention of the business rules. For example, if a certain business rule requires two distinct approvals for every invoice over ten thousand dollars, then a violation (i.e., irregularity) of the business rule would be every invoice (e.g., business data) over ten thousand dollars with only one or no approvals. Accordingly, the audit management application provides the business or auditor a means of verifying that the controls (e.g., the business rules) established by the business to curb fraud are actually adhered to in the course of normal business activity. In an embodiment, the detection strategies correspond to predefined business rules. In another embodiment, the user (i.e., the auditor) can also develop detection strategies by defining certain rules on the business data (e.g., invoices) directly or reusing existing business rules. In an embodiment, executing the detection task applies the detection strategy (i.e., business rules) to the desired business data. In an embodiment, the detection task is executed after approval of the detection task from an audit manager. In an embodiment, the detection task is executed utilizing an in-memory, relational database management systems, e.g., SAP® HANA. Following the execution of the detection task, the audit management application retrieves the irregularities of the executed business data. In other words, the audit management application retrieves the instances of the business data which potentially violated and/or circumvented a certain business rule defined in the detection strategy. In an embodiment, the instances of the potential violations of the business rules (i.e., irregularities) are aggregated in a working paper corresponding to the detection task as alert items. In an embodiment, the working paper is a data object which collects and links all the irregularities (i.e., alert items which will have to be examined and confirmed by an auditor) created during the execution of the detection task. In an embodiment, in an execution of a specific detection task, the audit management application determines whether or not a working paper corresponding to the detection task already exists. If a working paper does exist, the audit management application updates the existing working paper. In an embodiment, if a time frame of a current execution of a detection task overlaps with a time frame of a previous execution of the same detection task, then the alert items (i.e., irregularities) of the working paper corresponding to the overlapped time frame of the previous execution will be overwritten with the new alert items corresponding to the current execution. Further, in an embodiment, for time frames of the current execution of the detection task with no overlap with the previous execution, the working paper will be updated with alert items corresponding to the current execution of the detection task. On the other hand, if a working paper does not exist, then the audit management application will generate one during the execution of the detection task and update the generated working paper with alert items corresponding to the executed detection task. In an embodiment, after the working paper is updated with the most recent alert items, an auditor has to investigate each alert item in order to verify and confirm which alert items are actually proven frauds and which are false positives (i.e., no fraud). In an embodiment, after an investigation, the auditor updates the working paper indicating whether the alert item is a proven fraud (i.e., a failure of the established controls) or a false positive (i.e., there was no fraud and the established controls were effective). Furthermore, in an embodiment, the updated working papers can be further integrated into one or more audit engagements (i.e., the total audit performed by the auditor) as a finding. In an embodiment, the audit engagement can also include recommendations for the auditee (or a representative thereof) to rectify the control failure. In an embodiment, the audit engagement with the linked working papers can then be submitted to an auditee. In an embodiment, after the audit engagement is submitted to the auditee, the detection task corresponding to the control failures listed in the working paper is re-executed. Accordingly, the audit management application can determine if the auditee followed the recommendations set forth in the audit engagement in order to rectify the control failure. In an embodiment, the re-execution of the detection task is performed by the audit management application after a period of time providing the auditee the ability to rectify the control failure. In an embodiment, only the business data corresponding to the control failures is re-analyzed during the re-execution of the detection task.

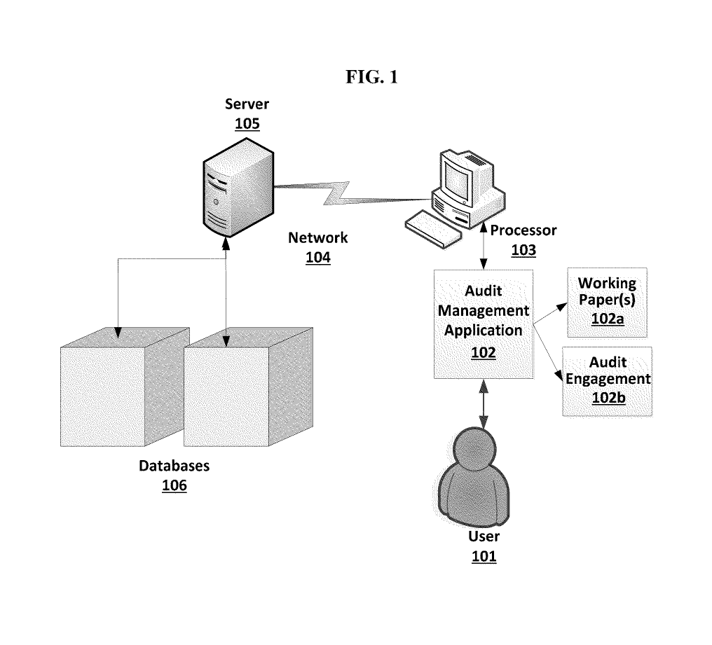

FIG. 1 illustrates an embodiment of a system utilizing the audit management application. In an embodiment, the system 100 consists of a user 101, an audit management application 102 (with corresponding working paper(s) 102a and audit engagement 102b), a processor (with a display) 103, a network 104, a server 105, databases 106. In an embodiment, audit management application 102, working paper(s) 102a and audit engagement 102b are utilized within the same user interface. In another embodiment, audit management application 102, working paper(s) 102a and audit engagement 102b are utilized within separate user interfaces. Further, in an embodiment, databases 106 is an in-memory database.

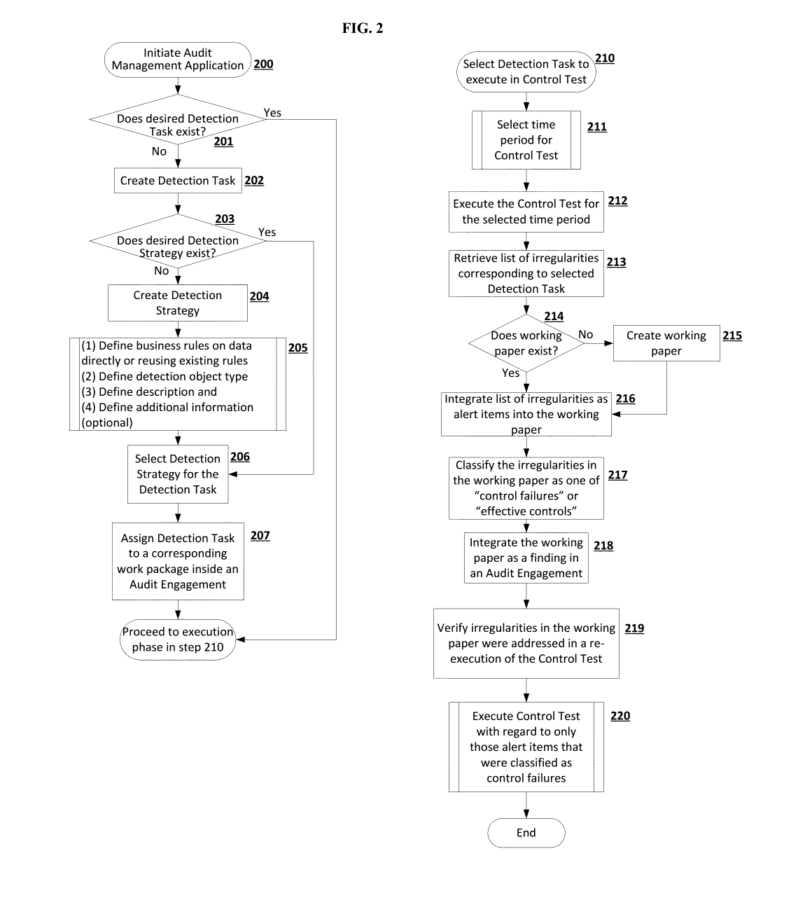

FIG. 2 illustrates an embodiment of a method of utilizing the audit management application. In step 200, the audit management application is initiated. In step 201, it is determined if a desired Detection Task exists. If a desired Detection Task exists, then the method proceeds to the execution phase in step 210; otherwise, the method proceeds to step 202. In step 202, a new Detection Task is generated. In step 203, it is determined if a desired Detection Strategy, corresponding to the Detection Task, exists. If a desired Detection Strategy exists, the method proceeds to step 206; otherwise, the method proceeds to step 204. In step 204, a new Detection Strategy is generated. In order to generate a new Detection Strategy, as depicted in step 205, a user has to: (1) define business rules on the data directly or reuse existing rules, (2) define the detection object type, (3) define a description and (4) define additional information. In step 206, a desired Detection Strategy is selected for the Detection Task. In step 207, the Detection Task is assigned to a corresponding work package inside an Audit Engagement. After step 207, the method proceeds to the execution phase in step 210. In step 210, a Detection Task is selected to be executed in a Control Test. In step 211, the time period for the Control Test is selected. In step 212, the Control Test for the selected time period is executed. In step 213, a list of irregularities corresponding to the selected Detection Task is retrieved. In step 214, it is determined whether a working paper exists. If a working paper exists, the method proceeds to step 216; otherwise, the method proceeds to step 215. In step 215, a working paper is generated. In step 216, the list of irregularities is integrated into the working paper as alert items. In step 217, irregularities in the working paper are classified as one of a “control failure” or an “effective control.” In step 218, the working paper is integrated into an Audit Engagement as a finding. In step 219, a re-execution of the Control Test is performed in order to verify that the aforementioned irregularities were addressed. Accordingly, in step 220, the Control Test is re-executed with regard to only those alert items which were classified as control failures in the working paper.

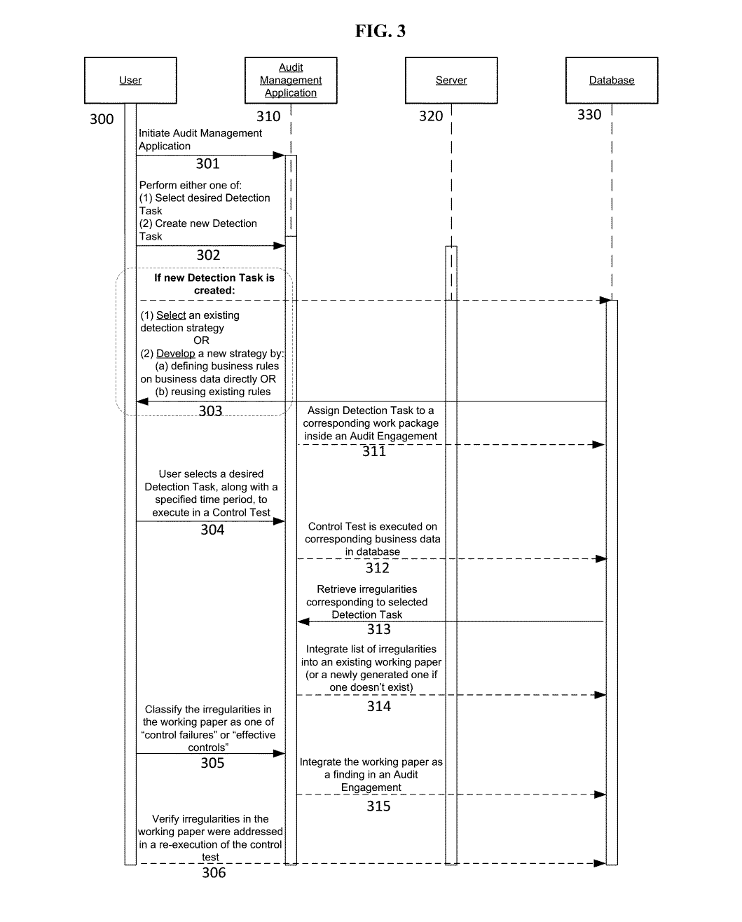

FIG. 3 illustrates an embodiment of the interaction between the elements of the system. In an embodiment, in step 301, the user 300 initiates Audit Management Application 310. In step 302, the user 300 either (1) selects a desired Detection Task or (2) creates a new Detection Task. In Step 303, if the user 300 decides to create a new Detection Task, the user has to either (1) select an existing Detection Strategy or (2) develop a new strategy by: (a) defining business rules on business data directly or (b) reusing existing business rules. In step 311, the Audit Management Application 310 assigns the Detection Task to a corresponding work package inside an Audit Engagement at databases 330. In step 304, user 300 selects a desired Detection Task, along with a specified time period, to execute in a Control Test with Audit Management Application 310. In step 312, the Audit Management Application 310 executes the Control Test on the corresponding business data in the databases 330. In step 313, irregularities corresponding to the selected Detection Task are retrieved from databases 330 with Audit Management Application 310. In step 314, the retrieved list of irregularities are integrated into an existing (or newly generated if one doesn't exist) working paper in databases 330 with Audit Management Application 310. In step 305, the user 300 classifies the irregularities in the working paper as one of “control failures” or “effective controls.” In step 315, the Audit Management Application 310 integrates the working paper as a finding in an Audit Engagement in databases 330. Finally, in step 306, the user 300 re-executes the Control Test after a certain period of time in order to verify that the irregularities in the working paper were addressed.

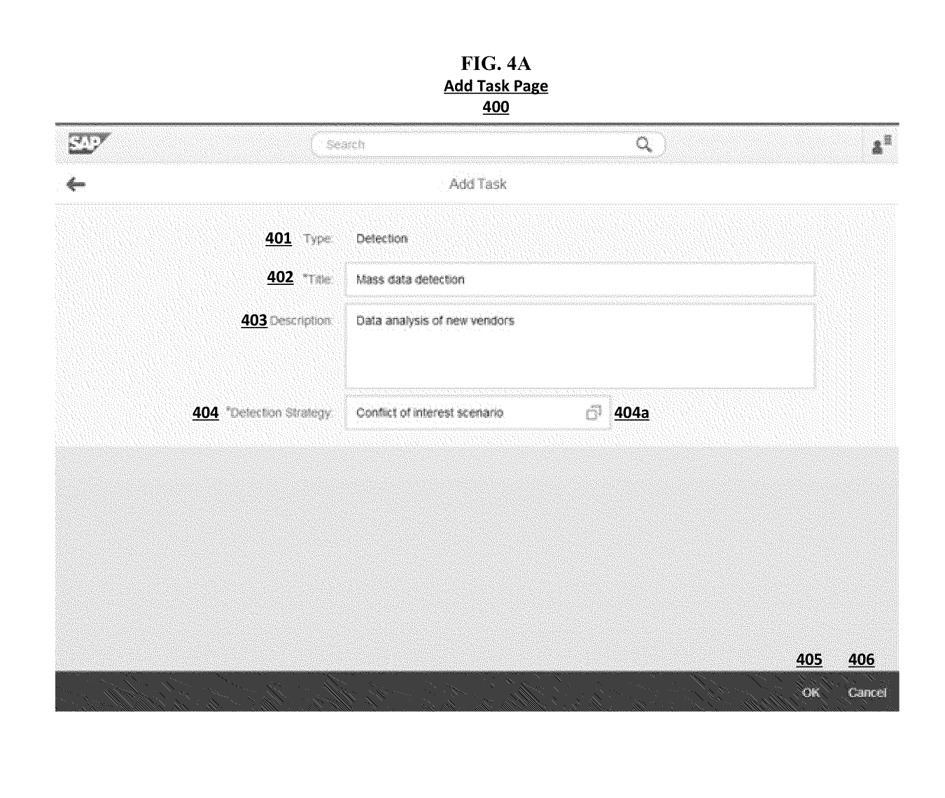

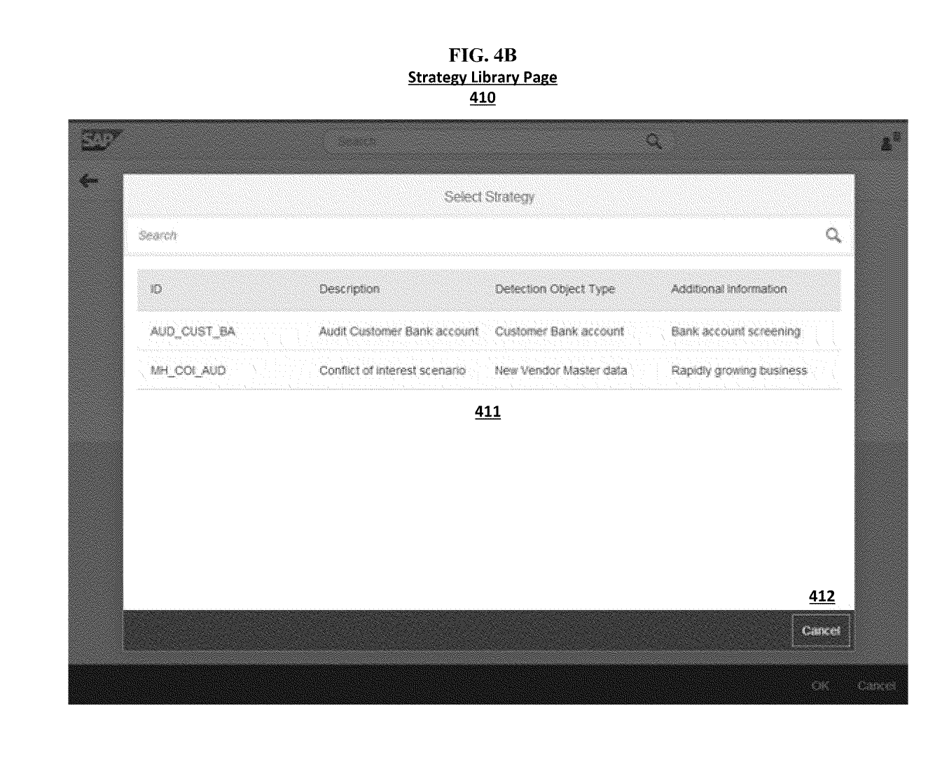

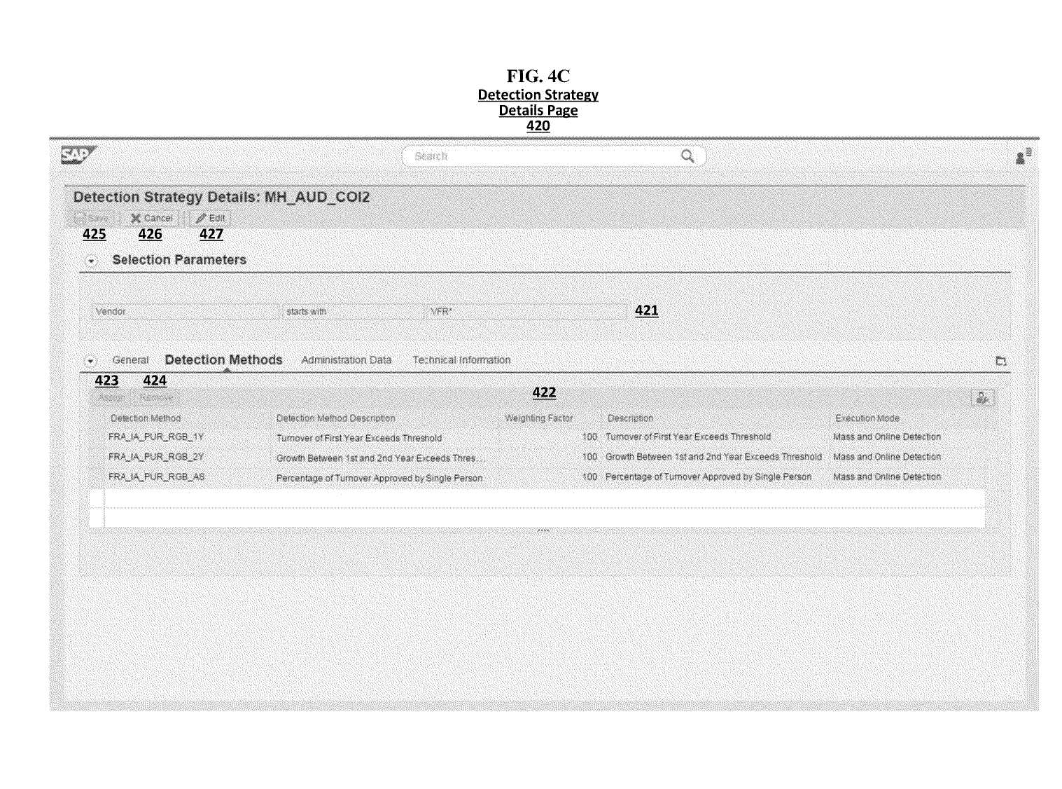

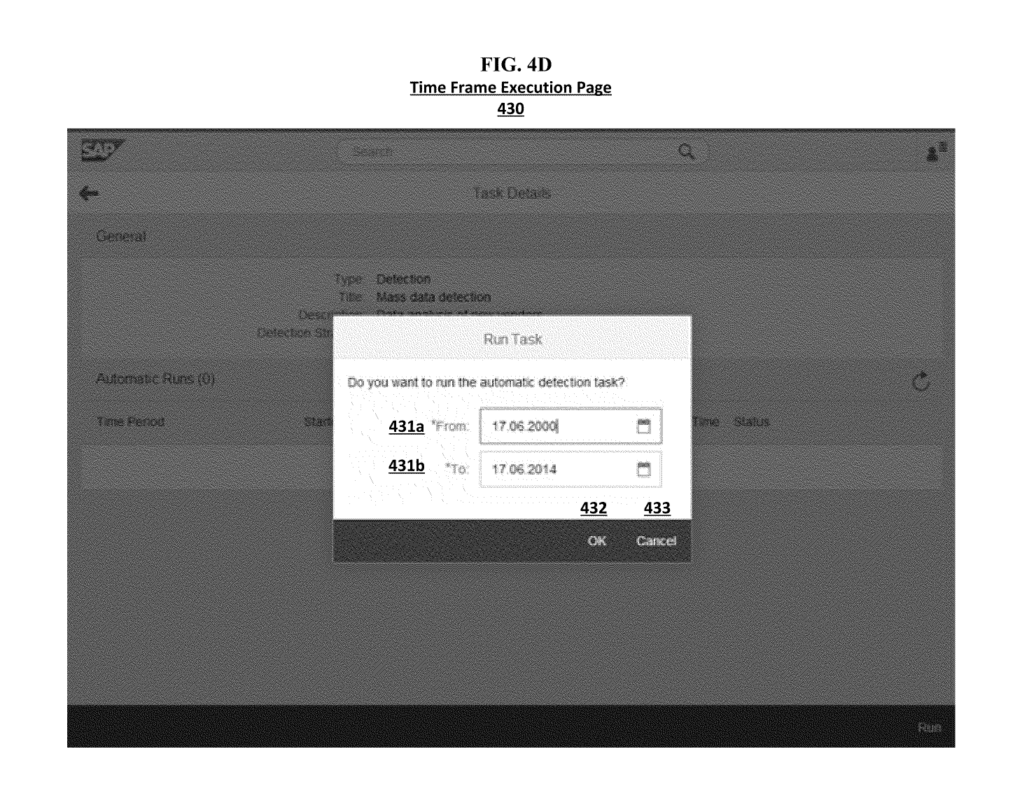

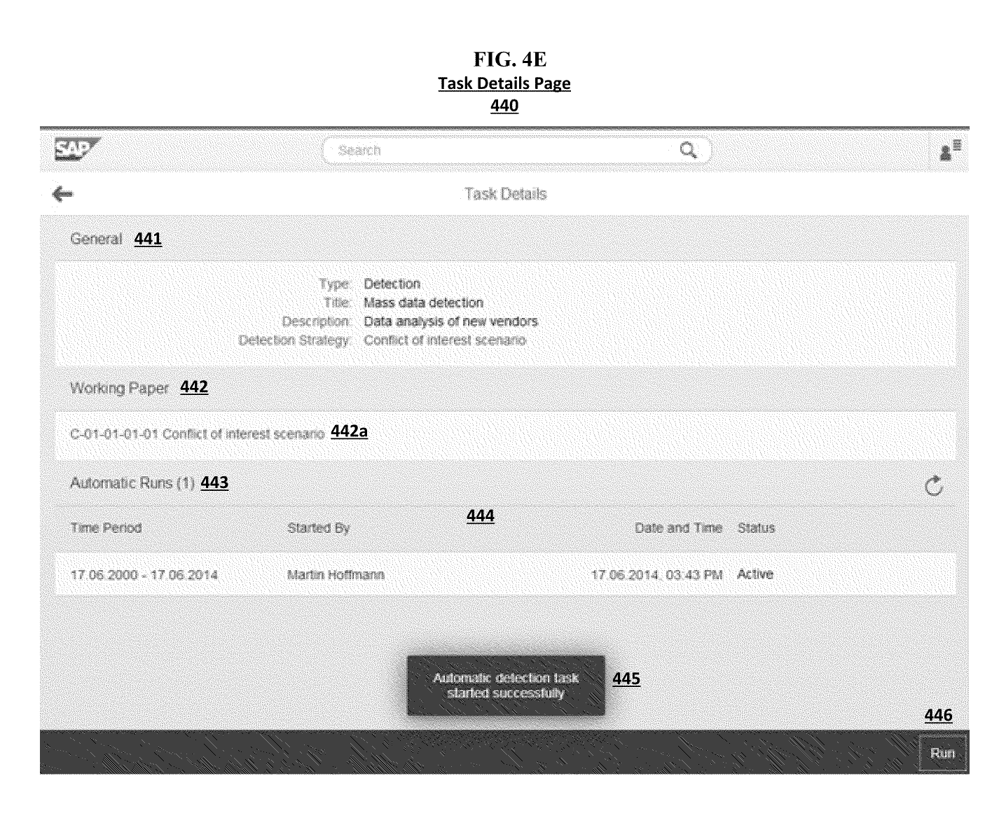

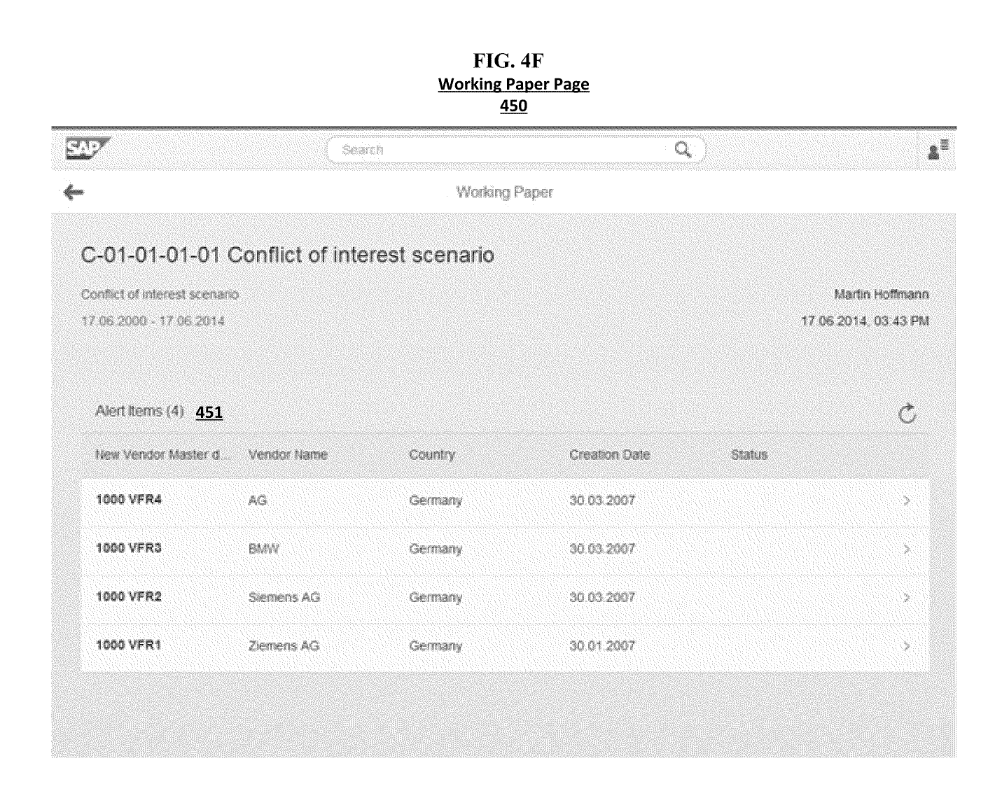

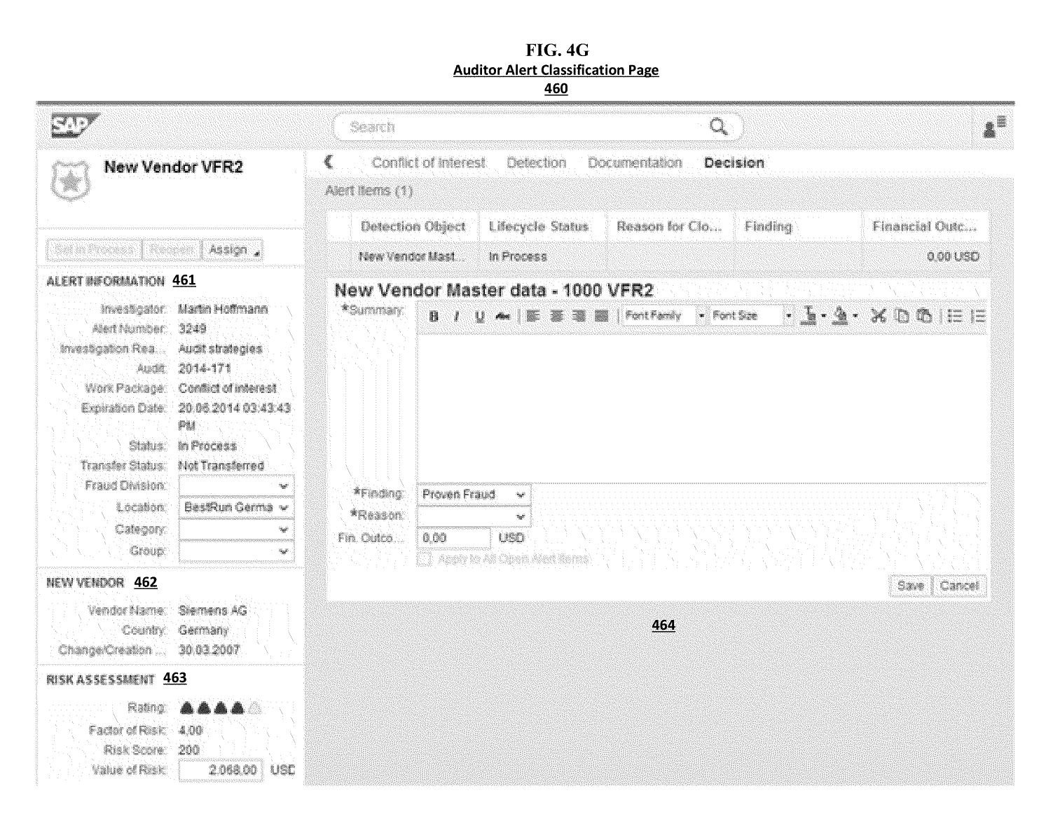

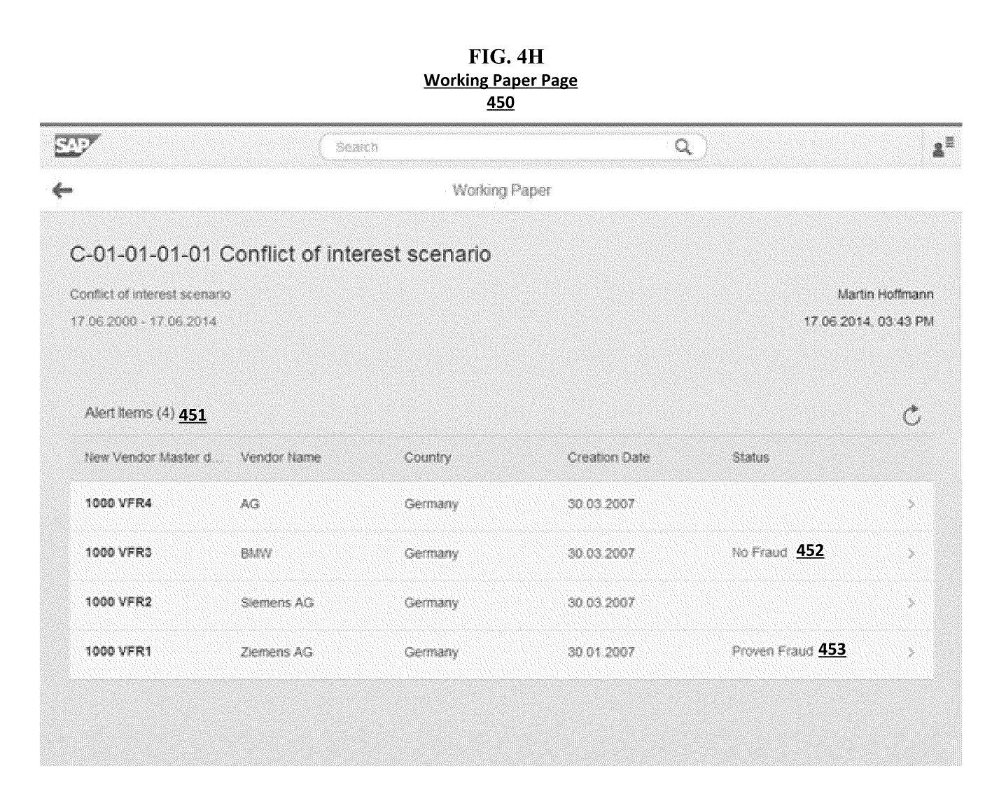

FIG. 4A illustrates an embodiment of a page utilized to add a detection task. In an embodiment, add task page 400 includes a task type input field 401, a task title input field 402, a task description input field 403, and a detection strategy input field 404. In an embodiment, detection strategy input field 404 includes detection strategy library button 404a. In an embodiment, selecting button 404a causes the strategy library page 410 to display. In an embodiment, the add task page 400 also includes a confirmation button (“OK”) 405 and a cancel button 406.

FIG. 4B illustrates an embodiment of a page utilized to select a detection strategy for a detection task. In an embodiment, strategy library page 410 includes a strategy list 411 and cancel button 412. In an embodiment, the strategies listed in strategy list 411 are defined by (1) a specific ID, (2) a description of the strategy, (3) the detection object type and (4) additional information (if necessary). In an embodiment, the detection object type refers to the type of the data (e.g., customer bank counts, new vendor master data, etc.) the strategy will act upon.

FIG. 4C illustrates an embodiment of a page utilized to create a detection strategy for a detection task. In an embodiment, detection strategy details page 420 includes a parameters field 421, detection methods field 422, an assign button 423, a remove button 424, a save button 425 (e.g., to save the detection strategy), a cancel button 426 (e.g., to cancel the detection strategy details page 420) and an edit button 427 (e.g., to edit the detection strategy). In an embodiment, the parameters field 421 allows a user (e.g., an auditor) to define a specific type of business data that a potential detection strategy will act up on. For example, in an embodiment, the user can define the strategy to only act upon vendors within the business data. Further, in another embodiment, the user can further define the selected type of business data with the parameters field 421. For example, in an embodiment, the user can define that the detection strategy will only act upon vendor business data that starts, contains or ends with a certain group of characters (e.g., numbers, letters, etc.). Further, in an embodiment, the user can select the type of business rules (e.g., detection methods) that will be applied to the selected business data with detection methods field 422. In an embodiment, the user is able to assign and remove desired detection methods with assign button 423 and remove button 424, respectively. Further, in an embodiment, for each selected detection method, detection methods field 422 includes the name of the method, a description of the detection method, a weighting factor for the detection method, and the execution method (e.g., mass and online detection). In an embodiment, after a detection task has been applied to the selected business data, the detection methods corresponding to the applied detection task can no longer be changed. In another embodiment, a user can modify the detection methods of the detection strategy even after it has been applied to the selected business data. Accordingly, in an embodiment, the user is able to tailor the detection methods of the audit as the user sees fit during the course of the audit. For example, in an embodiment, the user can modify the detection methods in order to either narrow or broaden the range of audited business data.

FIG. 4D illustrates an embodiment of a page utilized to select the time frame for a control test of a detection task. In an embodiment, time frame execution page 430 includes a start time input field 431a and an end time input field 431b. In an embodiment, the time frame execution page 430 also includes a confirmation button (“OK”) 432 and a cancel button 433. In an embodiment, selecting the confirmation button 432 begins the execution of the selected detection task and causes task details page 440 to display.

FIG. 4E illustrates an embodiment of a page depicting the details of the detection task. Task details page 440 includes general information area 441, working paper area 442 and task execution area 443. In an embodiment, general information area 441 includes information regarding (1) the type of task, (2) the title of the task, (3) a description of the task and (4) the detection strategy utilized. In an embodiment, working paper area 442 includes a linked working paper 442a. In an embodiment, if a working paper corresponding to the task already exists, that same working paper is linked to the task details page 440; otherwise, a new working paper is generated during the execution of the detection task and linked to the task details page. In an embodiment, selecting linked working paper 442a causes working paper page 450 to display. In an embodiment, task execution area 443 includes a summary list 444 of all of the execution runs corresponding to the task. In an embodiment, each execution run of the summary list 444 includes information regarding (1) the time period included in the execution of the task, (2) the user who initiated the execution of the task, (3) the date and time of the execution of the task and (4) the status of the execution (e.g., active). In an embodiment, task execution area 443 also includes a task execution indicator 445. In an embodiment, task execution indicator 445 indicates whether the detection task started successfully or not. In an embodiment, the task details page 440 also includes a run button 446. In an embodiment, selecting run button 446 re-executes the task.

In an embodiment, after an auditor submits an audit engagement to the auditee, the task details page 440 is utilized again in order to check whether the irregularities determined by the audit were addressed. In an embodiment, the task details page 440 is utilized to re-execute the detection task on only the business data corresponding to the control failures (e.g., “proved fraud”). In an embodiment, the business data corresponding to the control failures is automatically generated from the initial execution of the detection task. Accordingly, in an embodiment, in the re-execution of the detection task, the size of the business data processed is much smaller than the initial execution.

FIG. 4F illustrates an embodiment of a page representing the contents of a working paper. In an embodiment, working paper page 450 includes a list of alert items 451 (e.g., irregularities) retrieved as a result of executing the detection task.

FIG. 4G illustrates an embodiment of a page utilized to classify irregularities in the working paper. In an embodiment, auditor alert classification page 460 includes alert information area 461, vendor information area 462, risk assessment area 463 and auditor findings area 464. In an embodiment, alert information area 461 includes information corresponding to the instantaneous alert item (e.g., name of the investigator/auditor, alert number, audit number, corresponding work package, etc.). In an embodiment, vendor information corresponding to the alert item is depicted in vendor information area 462 (e.g., vendor name, country of origin, etc.). In an embodiment, a user is able to provide a risk assessment (e.g., rating, factor of risk, risk score and value of risk) in the risk assessment area 463. In an embodiment, the alert items corresponding to the working paper page 450 are classified by a user (e.g., an auditor) as one of a “proven fraud” (e.g., control failure) or “no fraud” (e.g., control effective) in auditor findings area 464.

FIG. 4H illustrates another embodiment of the page representing the contents of a working paper. In an embodiment, working paper page 450 includes the classifications for the alert items 451 determined by a user utilizing auditor findings area 464 of the auditor alert classification page 460. For example, in an embodiment, status 452 indicates that there was no fraud (i.e., control effective in the audit context) and status 453 indicates that there was proven fraud (i.e., control failure in the audit context).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Although the foregoing invention has been described in some detail for purposes of clarity of understanding, it will be apparent that certain changes and modifications can be practiced within the scope of the appended claims. The described embodiment features can be used with and without each other to provide additional embodiments of the present invention. The present invention can be practiced according to the claims without some or all of these specific details. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A computer-implemented method for analyzing business data with an audit management graphical user interface application, the method comprising:
retrieving, with a processor, from a database, a detection task, wherein the detection task includes a detection strategy, wherein the detection strategy corresponds to (1) business rules and (2) certain business data in the database;
executing, with the processor, in a first execution, a control test of the detection task as a function of (1) the detection strategy and (2) a start and end time of the certain business data to be used in the control test;
retrieving, with the processor, after the execution of the control test, a list of the certain business data in potential violation of the business rules associated with the detection strategy;
integrating, with the processor, the list of the certain business data in potential violation of the business rules as a list of alerts into a working paper in the database;
classify, with the processor, as a function of user-defined findings for the list of alerts in the working paper, the list of alerts in the working paper as one of (1) a proven fraud and (2) no fraud; and
generate, with the processor, at least one audit engagement linking to the working paper including the classified list of alerts.

2. The method of claim 1, wherein the business rules correspond to internal rules of a business utilized to curb fraud.

3. The method of claim 1, wherein the working paper is one of (1) newly generated after the execution of the control test or (2) existed prior to the execution of the control test.

4. The method of claim 1, wherein the detection strategies are user-modifiable.

5. The method of claim 4, wherein the detection strategies are a function of one of (1) user-defined business rules directly corresponding to the business data or (2) reused existing business rules.

6. The method of claim 1, further comprising:
executing, with the processor, in a second execution, the control test as a function of (1) the detection strategy, (2) the start and end time of the certain business data used in the control test and (3) the list of alerts in the working paper classified as a proven fraud.

7. The method of claim 1, wherein the executing step is performed utilizing an in-memory, relational database management system.

8. A non-transitory computer readable medium containing program instructions to analyze business data with an audit management graphical user interface application, wherein execution of the program instructions by one or more processors of a computer system causes one or more processors to carry out the steps of:
retrieving, from a database, a detection task, wherein the detection task includes a detection strategy, wherein the detection strategy corresponds to (1) business rules and (2) certain business data in the database;
executing, in a first execution, a control test of the detection task as a function of (1) the detection strategy and (2) a start and end time of the certain business data to be used in the control test;
retrieving, after the execution of the control test, a list of the certain business data in potential violation of the business rules associated with the detection strategy;
integrating the list of the certain business data in potential violation of the business rules as a list of alerts into a working paper in the database;
classify as a function of user-defined findings for the list of alerts in the working paper, the list of alerts in the working paper as one of (1) a proven fraud and (2) no fraud; and
generate at least one audit engagement linking to the working paper including the classified list of alerts.

9. The non-transitory computer readable medium of claim 8, wherein the business rules correspond to internal rules of a business utilized to curb fraud.

10. The non-transitory computer readable medium of claim 8, wherein the working paper is one of (1) newly generated after the execution of the control test or (2) existed prior to the execution of the control test.

11. The non-transitory computer readable medium of claim 8, wherein the detection strategies are user-modifiable.

12. The non-transitory computer readable medium of claim 11, wherein the detection strategies are a function of one of (1) user-defined business rules directly corresponding to the business data or (2) reused existing business rules.

13. The non-transitory computer readable medium of claim 8, further comprising:
executing, in a second execution, the control test as a function of (1) the detection strategy, (2) the start and end time of the certain business data used in the control test and (3) the list of alerts in the working paper classified as a proven fraud.

14. A system directed to analyzing business data with an audit management graphical user interface application, comprising of:
a database;
a processor, wherein the process is configured to perform the steps of:
retrieving, from the database, a detection task, wherein the detection task includes a detection strategy, wherein the detection strategy corresponds to (1) business rules and (2) certain business data in the database;
executing, in a first execution, a control test of the detection task as a function of (1) the detection strategy and (2) a start and end time of the certain business data to be used in the control test;
retrieving, after the execution of the control test, a list of the certain business data in potential violation of the business rules associated with the detection strategy;
integrating the list of the certain business data in potential violation of the business rules as a list of alerts into a working paper in the database;
classify as a function of user-defined findings for the list of alerts in the working paper, the list of alerts in the working paper as one of (1) a proven fraud and (2) no fraud; and
generate at least one audit engagement linking to the working paper including the classified list of alerts.

15. The system of claim 14, wherein the business rules correspond to internal rules of a business utilized to curb fraud.

16. The system of claim 14, wherein the working paper is one of (1) newly generated after the execution of the control test or (2) existed prior to the execution of the control test.

17. The system of claim 14, wherein the detection strategies are user-modifiable.

18. The system of claim 17, wherein the detection strategies are a function of one of (1) user-defined business rules directly corresponding to the business data or (2) reused existing business rules.

19. The system of claim 14, further comprising:
executing, in a second execution, the control test as a function of (1) the detection strategy, (2) the start and end time of the certain business data used in the control test and (3) the list of alerts in the working paper classified as a proven fraud

20. The system of claim 14, wherein the executing step is performed utilizing an in-memory, relational database management system.
